(19) United States
(12) Patent Application Publication
(10) Pub. No.: US 2009/0139640 A1
(43) Pub. Date: Jun. 4, 2009

(54) Process for Producing Partially Metallized Substrates

(76) Inventors: Roland Treutlein, Pirk (DE); Johann Hilburger, Pirk (DE); Martin Bergsmann, Linz (AT); Peter Reich, Pirk (DE)

Correspondence Address: WENDEROTH, LIND & PONACK, L.L.P., 1030 15th Street, N.W.,, Suite 400 East, Washington, DC, 20005-1503, US

(21) Appl. No.: 12/086,171

(22) PCT Filed: Feb. 5, 2007
(86) PCT No.: PCT/EP2007/000941

§ 371 Date: Jul. 24, 2008

(30) Foreign Application Priority Data
Feb. 6, 2006 (EP) 06002358.7

(51) Int. Cl. B32B 37/00

(52) U.S. Cl. 156/233

(57) ABSTRACT

Process for producing a partially metalized substrate, characterized by the following process steps: a) provision of a first substrate, b) partial printing or coating of the substrate with a surface coating which adheres only weakly to the substrate, c) application of a full-area metal layer, d) lamination to an adhesive-coated second substrate and e) detachment of this second adhesive-coated substrate, as a result of which the weakly adhering surface coating with the metallic layer on top of it is detached from the first substrate and a structured metallic layer thus remains on the first substrate.

The invention discloses a process for the production of partially metalized carrier substrates.

Partially metalized carrier substrates are used for e.g. in the electronics industry as traces, antennae, RF-antennae, conductive contacts, contact surfaces for printed circuits or contact pins for ICs.

In addition, metalized or partially metalized carrier substrates are used as safety elements in various forms (strips, threads, patches etc.) in or on data carriers, securities such as bank notes, passports, etc., in or on packaging etc.

WO 99/13157 A1 discloses protective foils for securities, in which a metallic coat is applied on a translucent foil, which does not cover the whole surface but instead has open areas which should be clearly visible with transmitted light. The production of these foils includes a carrier foil printed with a highly-pigmented printing ink, wherein the colour application is not on the complete surface; the printing ink is dried under formation of a porous colour coat, finally a metallic top coat is applied and in a further step the highly-pigmented printing ink is removed by washing out with a solvent or if required also by mechanical action. Thus, in areas where the printing ink is removed, the metallic top coat is also removed, thereby forming the open areas seen with transmitted light. The metallic top coat has a thickness of 0.01 to 1 μm.

WO 02/31214 A1 discloses a partially metalized foil and a process for its production, whereby a pattern is printed, with a dissolvable colour, on a substrate or a carrier foil, and/or the basic materials are cleaned directly in a vacuum by means of plasma treatment and simultaneously seeded with target atoms, wherein a metal is metalized and finally the structured layer is created by washing out of the dissolvable colours or through etching.

Especially when using a wash process for removing the partially applied dissolvable colour with the separated top metal coat, mechanical support for the washing process is necessary. Most often this leads to the scratching of the residual metal coat applied on the substrate.

Moreover, both processes are relatively time-consuming consisting of numerous process steps. Generally therefore, high production speeds cannot be achieved.

The function of the invention was to prepare a process for the production of a partially metalized carrier substrate, which would allow high production speeds with sufficient precision and high quality.

Object of the invention is therefore, a process for production of a partially metalized carrier substrate, characterized by the following process steps:
a) Preparation of a first/initial carrier substrate
b) Partial printing or coating of the carrier substrate with a weak adhesive coat on the carrier substrate
c) Application of a metallic layer on the complete surface
d) Bonding against an adhesive-coated second carrier substrate and
e) Separation of this second adhesive-coated carrier substrate,
whereby the weak adhesive paint with a metallic coat over it, is removed from the first carrier substrate, leaving behind a structured metallic coat on the first carrier substrate.

Carrier substrates could be for e.g. carrier foils, preferably flexible plastic foils made of PI, PP, OPP, PPS, PEEK, PEK, PEI, PSU, PAEK, LCP, PEN, PBT, PET, PA, PC, COC, POM, ABS, PVS, Fluor polymers such as Teflon, etc. The carrier foils preferably have a thickness of 5-700 μm, better 5-200 μm, most preferred 36-75 μm.

Carrier substrates could also be made of metal foils such as for e.g. Al, Cu, Sn, Ni, Fe or stainless steel, with a thickness of 5-200 μm, preferably 10 to 80 μm, most preferred 10-40 μm. The foils can also be surface treated, coated or covered with for e.g. plastics or paint.

Moreover, carrier substrates made of paper or composite materials with paper e.g. composites with plastics with a grammage of 20-500 g/m², preferably 40-200 g/m² can be used.

Non-wovens such as filament fleece, staple fibre fleece, etc. can also be used as carrier substrates, which can then be needled or calendered, if required. Preferably such fleece contains plastics such as PP. PET, PA, PPS, etc., however, fleece made of natural and treated fibres such as viscose fibres can also be used. The fleece used has a grammage of around 20-500 g/m².

Subsequently a weak adhesive paint or coat is partially applied to this first carrier substrate. The paint can be applied as lines, samples, tracks, symbols, drawings, etc.

This helps in applying the paint in those areas where there are metal-free areas in the finished product.

In a particular design type, the pattern on the second carrier substrate can show the finished product after the separation. Through this for e.g. traces made of materials such as polypropylene can be produced, which are not temperature stable during direct vaporization.

The removal of the weak adhesive coat on the carrier substrate can be done by means of a process such as gravure printing, flex printing, screen printing, digital printing, etc.

Weak adhesive paint coats that come into question are for e.g. paints or coats with methacrylate bases, with bases of polyamide, polyethylene, fluoropolymers, silicone, strong or thin oil coats.

Subsequently a metallic coat is applied. This coat consists of a metal, a metal composite, or an alloy. Coats made of Al, Cu, Fe, Ag, Au, Cr, Ni, Zn, etc. are suitable as metallic coats. As metal composites for e.g., oxides or sulfides of metals, especially TiO₂, Cr-oxide, ZnS, ITO, ATO, FTO, ZnO, Al₂O₃ or silicium oxide are appropriate. Suitable alloys are for e.g. the Cu—Al alloys, Cu—Zn alloys, etc.

The metallic coat is preferably consists of copper, aluminum, silver or gold.

This metallic coat can be applied by known processes such as metallization, sputtering, printing (gravure, flexo-graphic screen, digital, etc.), spraying, galvanization etc. The thickness of the functional coat is 0.001 to 50 μm, preferably 0.1 to 20 μm.

For clear identification of a certain production charge or an individual component or part of a production charge of the metalized carrier substrate produced as per the invention, in a particular design type the weak adhesive paint or coat can be applied individually by means of a digital printing process. Thereby the weak adhesive paint and/or coat can, if required, be applied additionally to the functional patterns described earlier, in such a way, that it covers the contour of the desired individualized code.

Subsequently, the design produced in such a manner is covered in the usual way against a carrier substrate with an adhesive coat. Preferably the carrier substrate has a self-adhesive coating. As carrier substrates one can consider a flexible plastic foil for e.g. made of PP, OPP, PE, PEI, PEN, PBT, PET, PA, PC, COC, POM, ABS, PVC etc.

Carrier substrates could also be made of metal foils such as for e.g. Al, Cu, Sn, Ni, Fe or stainless steel, with a thickness of 5-200 μm, preferably 10 to 80 μm, most preferred 10-40 μm. The foils can also be surface treated, coated or covered with for e.g. plastics or paint.

Moreover, carrier substrates made of paper or composite materials with paper e.g. composites with plastics with a grammage of 20-500 g/m², preferably 40-200 g/m² can be used.

Non-wovens such as filament fleece, staple fibre fleece, etc. can also be used as carrier substrates, which can then be needled or calendered, if required. Preferably such fleece contains plastics such as PP. PET, PA, PPS, etc., however, fleece made of natural and treated fibres such as viscose fibres can also be used. The fleece used has a grammage of around 20-500 g/m².

Moreover, carrier substrates made of paper or composite materials with paper e.g. composites with plastics with a grammage of 20-500 g/m², preferably 40-200 g/m² can be used.

Non-wovens such as filament fleece, staple fibre fleece, etc. can also be used as carrier substrates, which can then be needled or calendered, if required. Preferably such fleece contains plastics such as PP. PET, PA, PPS, etc., however, fleece made of natural and treated fibres such as viscose fibres can also be used. The fleece used has a grammage of around 20-500 g/m². In addition, composite materials with fleece, etc. can also be used.

Subsequently this carrier substrate is removed from the carrier substrate with the metallic coat.

Thereby the weak adhesive paint with the metallic coat over it, separates from the first carrier substrate and metallic, functional structures remain on the carrier substrate. Similarly, sometimes those metallic structures which form the individualized code on the carrier substrate remain.

The process as per the invention is simple and economical and can be executed with few process steps.

Since no washing or etching solution is used for making the partially metalized structures, this process is more environment-friendly and cost-effective as compared to present processes available.

The partially metalized carrier substrate produced as per the invention can be used for electronic components such as traces, antennae, RF-antennae, conductive contacts, contact surfaces for printed circuits or contact pins for ICs, if needed with an individualized code, etc.

In addition, the carrier substrates manufactured as per the invention can be used as safety elements in or on data carriers such as access cards, prize coupons, container covers with prize coupons, etc., or on securities such as bank notes, passports, in or on packaging etc.

### EXAMPLE:

On a 50 μm thick PEN foil, paint with a methacrylate base is applied partially by means of a gravure printing process.

Subsequently a metallic coating made of copper (0.5 μm) covering the entire surface, is applied using a PVD process.

The design produced in this manner is bonded against a PET foil with a conventional self-adhesive coating and subsequently separated again.

Through this removal process the coat of paint with the top coat separates displaying the metallic structure on the first carrier substrate.

1-10. (canceled)

11. Process for the manufacture of a partially metalized carrier substrate, comprising:
a) preparing of a first/initial carrier substrate,
b) partial printing or coating of the carrier substrate with a weak adhesive coat on the carrier substrate,
c) application of a metallic layer on the complete surface of b),
d) bonding against a adhesive-coated second carrier substrate and
e) separation of this second adhesive-coated carrier substrate,
whereby the weak adhesive paint with the metallic coat over it, is removed from the first carrier substrate, leaving behind a structured metallic coat on the first carrier substrate.

12. Process according to claim 11 wherein the carrier substrate used in step d) has a self-adhesive coating.

13. Process according to claim 11 wherein as weak adhesive paint or coats, a paint or coat with methacrylate base, or with base of polyamide, polyethylene, fluoropolymers, silicone, strong or thin oil coats, is used.

14. Process according to claim 11 wherein as a full surface metallic coat, a coat made of Al, Cu, Fe, Ag, Au, Cr, Ni, Zn, from oxides or sulfides of metals is applied.

15. Process according to claim 14 wherein said coat comprises TiO₂, Cr-oxide, ZnS, ITO, ATO, FTO, ZnO, Al₂O₃ or silicium oxide.

16. Process according to claim 11 wherein as a first carrier substrate, a flexible plastic foil made of PI, PP, OPP, PE, PPS, PEEK, PEK, PEI, PSU, PAEK, LCP, PEN, PBT, PET, PA, PC, COC, POM, ABS, PVS or fluoropolymers is used.

17. Process according to claim 16 wherein the fluoropolymer is PTFE or ETFE.

18. Process according to claim 11 wherein the second carrier substrate is a flexible foil made of PP, OPP, PE, PEI, PEN, PBT, PET, PA, PC, COC, POM, ABS or PVC.

19. Process according to claim 11 wherein the metallic structure transferred to the second carrier substrates constitutes a finished product.

20. Electronic components, traces, antennae, RF-antennae, conductive contacts, contact surfaces for printed circuits or contact pins for ICs comprising the partly metalized substrate of claim 11.

21. Electronic components, traces, antennae, RF-antennae, conductive contacts, contact surfaces for printed circuits or contact pins for ICs, with an individualized code, comprising the partly metalized substrate produced by the method of claim 11.

22. Safety elements in or on data carriers, securities or packaging, with an optional individual code, comprising the partly metalized carrier substrate produced by the method of claim 11.
